(19) United States
(12) Patent Application Publication
(10) Pub. No.: US 2004/0213426 A1
(43) Pub. Date: Oct. 28, 2004

(54) Apparatus, methods, and articles of manufacture for a microphone enclosure

(75) Inventor: Roderick MacRae, Lynchburg, VA (US)

Correspondence Address: TYCO ELECTRONICS CORPORATION, 4550 NEW LINDEN HILL ROAD, SUITE 450, WILMINGTON, DE, 19808, US

(73) Assignee: M/A-COM, Inc., Lowell, MA

(21) Appl. No.: 10/636,158

(22) Filed: Aug. 7, 2003

Related U.S. Application Data
(60) Provisional application No. 60/465,964, filed on Apr. 28, 2003.

(51) Int. Cl. H04R 3/00; H04R 9/08; H04R 11/04

(52) U.S. Cl. 381/355; 381/361

(57) ABSTRACT

The invention is directed to microphone enclosures. Embodiments of the invention include a microphone enclosure having at least one tortuous path through which sound may reach the microphone elements. Such a configuration helps to prevent an object such as a wire from passing through the microphone hole. The tortuous path of the inlet may have a change of direction, which prevents an object such as wire from entering the hole far enough to pierce the microphone gasket or microphone while also allowing water or other foreign object to be more easily cleared from the inlet by blowing through the system. In one embodiment, the tortuous path may comprise at least one inlet having a plurality of openings.

### CROSS REFERENCE TO RELATED APPLICATIONS

The present application claims the priority of U.S. Provisional Patent Application Ser. No. 60/465,964, filed on Apr. 28, 2003, which is herein incorporated in its entirety by reference.

### FIELD OF THE INVENTION

The field of the invention is audio reproduction systems, and more particularly microphone enclosures.

### BACKGROUND OF THE INVENTION

Many systems employing the use of microphones (e.g., portable hand held radios, cellular phones, etc.) must be designed to withstand adverse environmental conditions, such as exposure to rain or immersion in water. They must be able to recover quickly from such exposure to prevent an unacceptable reduction in operating performance.

During exposure to adverse conditions, water and other foreign matter may become trapped within the inlet holes to the microphone. The presence of water and other types of foreign matter in the microphone hole decreases the acoustic sensitivity of the microphone.

Open and unprotected microphone holes are typically cleared of water by passing air (e.g., ‘blowing”) across the microphone hole. This is possible because the holes have minimal surface area in contact with the water. This results in a low surface tension, which allows the water to be easily removed. However, an open, unprotected microphone hole offers no protection from an object such as a wire that could enter the hole and pierce the microphone gasket and/or the microphone element itself.

To address this, systems have been developed in the prior art that help prevent an object such as a wire from coming in contact with the microphone components, such as the microphone gasket and the microphone element, to prevent the object from damaging these components.

An example of such as system is shown in FIGS. 1(a)-(b). Due to surface tension forces, water or other foreign matter from rain and immersion may be held within the microphone hole. System such as the one shown in FIGS. 1(a)-(b) do not easily self-drain. Moreover, evacuating the water from the hole by blowing across the hole may be very difficult.

Accordingly, systems are needed that provide protection to the components of the microphone, while allowing water and other foreign matter to be more easily cleared from the system.

### SUMMARY OF THE INVENTION

The invention is directed to microphone enclosures. Embodiments of the invention include a microphone enclosure having at least one tortuous path through which sound may reach the microphone elements. Such a configuration helps to prevent an object such as a wire from passing through the microphone hole. The tortuous path of the inlet may have a change of direction, which prevents an object such as wire from entering the hole far enough to pierce the microphone gasket or microphone while also allowing water or other foreign object to be more easily cleared from the inlet by blowing through the system. In one embodiment, the tortuous path may comprise at least one inlet having a plurality of openings.

### BRIEF DESCRIPTION OF THE DRAWINGS

The foregoing and other aspects and advantages will be better understood from the following detailed description of the invention with reference to the drawings, in which:

FIGS. 1(a)-(b) illustrate a system of the prior art;

FIG. 2(a) is an embodiment of the invention; and

FIG. 2(b) is a cross-section along line B-B of FIG. 2(a).

### DETAILED DESCRIPTION

The invention will be understood more fully from the detailed description given below and from the accompanying drawings of the preferred embodiments of the invention; which, however, should not be taken to limit the invention to a specific embodiment, but are for explanation and understanding.

In the invention, a tortuous path microphone inlet may be used to help prevent an object such as a wire from coming in contact with the microphone components, to prevent the object from damaging these components, while allowing water and foreign matter to be more easily cleared from the inlet by blowing through the system.

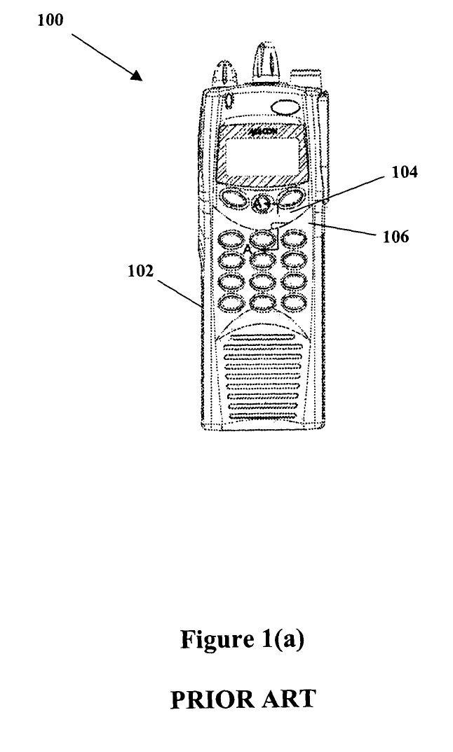

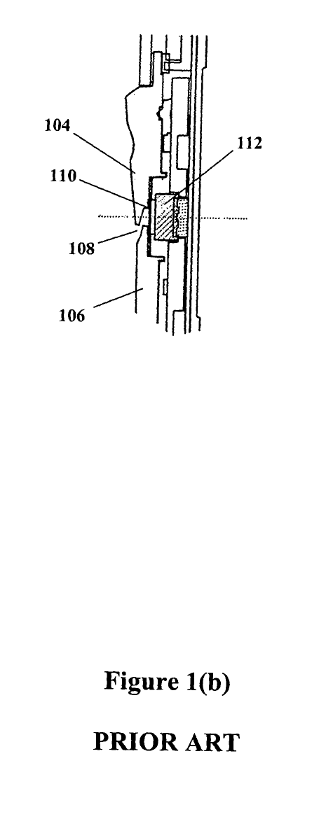

As noted above, an example of a prior art system is shown in FIGS. 1(a)-(b). The audio systems of the prior art (in this example a portable handheld radio 100) may typically have an outer casing 102, which contains the working components of the system, such as the microphone 112. One or portions of the outer casing may form an opening or inlet 118, allowing sound to enter the system and impinge upon the microphone. The microphone inlet has a change of direction, and this prevents the object from entering the hole far enough to pierce the microphone gasket or microphone.

Outer casing 102 may comprise a single piece or multiple pieces fitting together to contain the working components of the system. For example, outer casing 102 may have an upper portion 104 and a lower portion 106, which may form opening 118, allowing sound to enter the system and impinge upon microphone element 112 through a microphone gasket 110.

As may be seen in FIG. 1(b), inlet 120 is formed from a single opening 118. This configuration has a distinct disadvantage in that it does not provide a mechanism for easily passing air across the microphone components. Consequently, a user cannot easily clear water and other foreign matter from inlet 120, such as by blowing through the system. As a result water and foreign object may become trapped within the opening, significantly degrading the operation of the system.

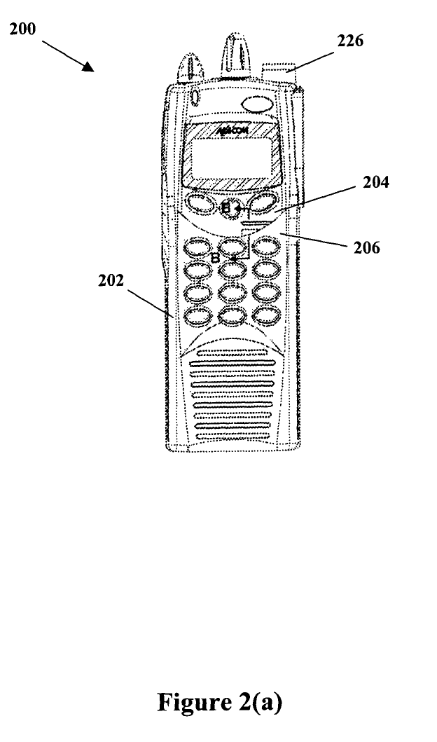

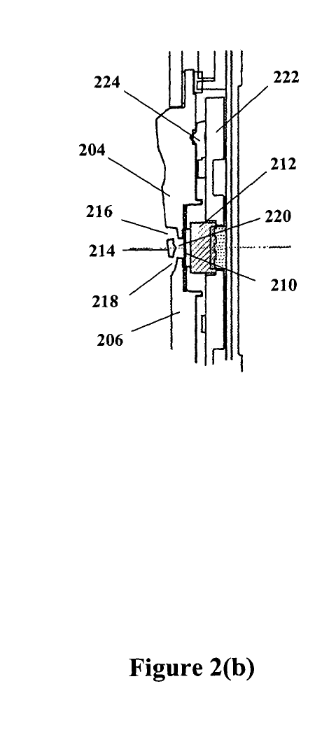

In sharp contrast, FIGS. 2(a)-(b) illustrate an embodiment of a system incorporating the invention. As shown in FIGS. 2(a)-(b), such a system 200 (in this example also a portable handheld radio) may have an outer casing 202, which contains the working components of the system, such as microphone element 212. Outer casing 202 may comprise a single piece or multiple pieces fitting together to contain the working components of the system.

Outer casing 202 may also have an upper portion 204, a middle portion 214 and a lower portion 206, which may form openings 216 and 218, allowing sound to enter the system and impinge upon microphone element 212 through microphone gasket 210. Those of ordinary skill in the art will appreciate that the reference to an upper, middle, and lower portion is for ease of explanation only and that those terms do not suggest any particular directional or spatial relationship among the components, and that opening 216 and 218 may be formed from a single component or multiple components, as well, and is not limited.

Microphone element 212 and microphone gasket 210 are also not particularly limited and may comprise any such components, the use of which are well known in the art and will not be further elaborated upon here.

As may be seen in FIG. 2(b), openings 216 and 218 may comprise a tortuous path to the microphone by converging to form inlet 220. The use of a tortuous path in this manner provides the significant advantage of minimizing the chance that an object, such as a wire, may come into contact with and cause damage to the microphone components, including microphone gasket 210, microphone element 212 circuit board 222, and integrated components 224, while also allowing water and other foreign matter to be cleared from the inlet, such as by blowing through the system. This allows sound to impinge freely upon microphone 212. Microphone 212 may then better convert the received sound into an electrical signal. This signal may be processed by integrated components 224 for transmission from the radio via antenna 226.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A microphone enclosure comprising:
a casing for containing a microphone for receiving sound and converting said sound into at least one electrical signal; and
at least one inlet for allowing sound to reach said microphone; said at least one inlet having a plurality of openings forming at least one tortuous path therein.

2. The microphone enclosure of claim 1, wherein said at least one inlet comprises an upper and a lower opening, said upper and lower opening converging at said microphone.

3. The microphone enclosure of claim 2, wherein said casing comprises an upper portion, a middle portion, and a lower portion which form said upper and lower openings.

4. The microphone enclosure of claim 1, wherein said microphone enclosure further contains a circuit board; integrated components on said circuit board for receiving signals from said microphone; and an antenna in communication with said integrated components for transmitting said electrical signal.

5. The microphone enclosure of claim 1, further comprising a microphone gasket proximate said microphone.

6. A microphone enclosure comprising:
a casing for containing a microphone for receiving sound and converting said sound into at least one electrical signal;
an first opening proximate said microphone;
a second opening proximate said microphone, and
at least one inlet formed by a convergence of said first opening and said second opening for allowing sound to impinge upon said microphone.

7. The microphone enclosure of claim 5, wherein said casing comprises an upper portion, a middle portion, and a lower portion which form said upper and lower openings.

8. The microphone enclosure of claim 5, wherein said microphone enclosure further contains a circuit board; integrated components on said circuit board for receiving signals from said microphone; and an antenna in communication with said integrated components for transmitting said electrical signal.

9. The microphone enclosure of claim 5, further comprising a microphone gasket proximate said microphone.

10. A portable radio comprising:
a circuit board;
integrated components on said circuit board for transmitting and receiving signals to and from said portable radio;
an antenna in communication with said integrated components for transmitting and receiving said signals;
a microphone in communication with said integrated components on said circuit board for converting between sound and electrical signals;
a casing for containing a microphone, said integrated components, and said circuit board;
an first opening in said casing proximate said microphone;
a second opening in said casing proximate said microphone, and
at least one inlet formed by a convergence of said first opening and said second opening for allowing sound to impinge upon said microphone.

11. The portable radio of claim 8, wherein said casing comprises an upper portion, a middle portion, and a lower portion which form said upper and lower openings.

12. The portable radio of claim 5, further comprising a microphone gasket proximate said microphone.
